(19) United States
(12) Patent Application Publication
(10) Pub. No.: US 2018/0161774 A1
(43) Pub. Date: Jun. 14, 2018

(54) HIGH EFFICIENCY MICROFLUIDIC DEVICE FOR TRAPPING CIRCULATING TUMOR CELLS

(71) Applicant: THE REGENTS OF THE UNIVERSITY OF CALIFORNIA, Oakland, CA (US)

(72) Inventors: Dino DI CARLO, Los Angeles, CA (US); Manjima DHAR, Los Angeles, CA (US)

(73) Assignee: THE REGENTS OF THE UNIVERSITY OF CALIFORNIA, Oakland, CA (US)

(21) Appl. No.: 15/579,684

(22) PCT Filed: Jun. 17, 2016
(86) PCT No.: PCT/US2016/038230

§ 371 Date: Dec. 5, 2017

Related U.S. Application Data
(60) Provisional application No. 62/180,990, filed on Jun. 17, 2015.

(51) Int. Cl. B01L 3/00; G01N 1/34; G01N 15/14

(52) U.S. Cl. CPC B01L 3/502761; G01N 1/34; G01N 15/1484; G01N 2015/1062; B01L 2300/0864; B01L 2300/087; B01L 2400/0487; B01L 2200/0652

(57) ABSTRACT

A microfluidic device for trapping circulating tumor cells includes at least one microfluidic channel coupled to an inlet and an outlet, the at least one microfluidic channel having a height of less than 50 μm and a width less than 30 μm. A plurality of expansion regions are disposed along the length of the at least one microfluidic channel, each of the plurality of expansion regions is formed by an abrupt increase in the width of the at least one microfluidic channel, wherein the width of each expansion region is within the range of 526 μm to 626 μm and continues for a length within the range of 814 μm to 914 μm along a length of the expansion region, followed by an abrupt decrease in the width of the at least one microfluidic channel back to a width less than 30 μm.

### RELATED APPLICATION

This Application claims priority to U.S. Provisional Patent Application No. 62/180,990 filed on Jun. 17, 2015, which is hereby incorporated by reference in its entirety. Priority is claimed pursuant to 35 U.S.C. § 119 and any other applicable statute.

### STATEMENT REGARDING FEDERALLY SPONSORED RESEARCH AND DEVELOPMENT

This invention was made with Government support under Grant N00014-12-1-0847 awarded by the Office of Naval Research. The Government has certain rights in the invention.

### TECHNICAL FIELD

The technical field generally relates to microfluidic devices for trapping small particles and in particular cells. The device and system can be used to efficiently trap high numbers of Circulating Tumor Cells (CTCs) that are larger than 10 μm.

### BACKGROUND OF THE INVENTION

CTCs obtained through liquid biopsies show promise as a tool for studying primary and metastatic tumors. CTCs open access to the genetic makeup and protein architecture of the primary and secondary tumors without an invasive biopsy. These cells are rare in the blood and they range from 1-10 CTCs/ml of whole blood. Challenges in isolating the CTCs involve processing large volumes of blood in a time effective manner and concentrating it into manageable volumes for analysis. Additionally, in order to perform cost-effective genomic analysis, highly pure samples are needed with low background noise from white blood cells. Immunomagnetic bead-based separation of CTCs generally uses EpCAM antibodies; however it misses any CTCs which have undergone Epithelial to Mesenchymal Transition due to EpCAM down regulation. Existing CTC isolation technologies that rely on physical properties of CTCs such as size based filtration, acoustic wave deflection, dielectrophoresis and size based inertial separation are still limited in throughput, pre-processing steps such as RBC-lysis and low sample purity.

Previous work on a prior embodiment of the Vortex Chip (Vortex Biosciences, Inc., Menlo Park, Calif.) has demonstrated its ability to use high throughput inertial microfluidics to passively enrich CTCs at high purity from large volumes of blood. The Vortex Chip highly efficiently captures low deformability cells larger than 15 μm in diameter. The prior embodiment of the Vortex Chip has lower capture efficiency, however, for cells that have a diameter within the range of 12 μm-15 μm. Due to the higher size cut off, the prior embodiment of the Vortex Chip misses trapping many potentially smaller-sized CTCs.

### SUMMARY

In one embodiment, an improved microfluidic device that has high efficiency at trapping small-sized CTCs is disclosed. The improved device, which is called herein the “Vortex HE” or “HE” devices, demonstrates high efficiency capture for a smaller cell size range (≥12 μm). The Vortex HE device has a higher capture efficiency for smaller cells as compared to the prior embodiment of the Vortex chip. This increase in performance has been achieved by, counter-intuitively, scaling down the dimensions of the microchannel that feeds into the expansion regions where vortices are formed while at the same time scaling up the dimensions of the individual expansion regions. This has produced an unexpected improvement in capture efficiency. Capturing the full range of CTCs will allow one to better understand the genotypic and phenotypic diversity of metastatic cancer.

In one embodiment, the Vortex HE device is a microfluidic device that uses high aspect ratio microfluidic channels that are used for particle focusing followed by a plurality of expansion regions. In one embodiment, the device has eight (8) expansion regions in series and eight (8) separate microfluidic channel in parallel, although different numbers of expansion regions and different numbers of parallel microfluidic channels can be used. There may be more or less expansion regions in a single channel. Likewise, there may be more or less separate, parallel microfluidic channels. Particle entry into the expansion regions that follow narrow focusing channels occurs due to the shear gradient lift force. The lift force is a balance between wall lift force pushing particles away from the wall and a transverse shear-gradient lift force determined by the fluid velocity profile around the particle. Small particles do not experience enough shear-gradient lift force, and focus towards the middle of the channel, and do not enter the expansion regions. Increasing the lift force by decreasing the cross-sectional area of the upstream focusing channels allow smaller particles to migrate across the mainstream and enter the expansion regions (e.g., trapped cells in expansion regions).

The Vortex HE device is able to trap a higher number of circulating tumor cells that are larger than 10 μm and smaller than 18 μm, while maintaining high purity. The improved Vortex HE device performs at a higher efficiency, although in some embodiments it may perform at lower purity. The higher efficiency makes it suitable for applications where purity of the isolated cells is not critical (e.g., cell culture). The Vortex HE device can also be used to isolate large white blood cells from whole blood, and can be used to filter or isolate cells or other particles from a variety of fluids, e.g., body fluids but also industrial fluids, municipal water, seawater, etc.

In one embodiment, a method of capturing CTCs from a patient sample using the Vortex HE device is provided. The method includes pumping a liquid biopsy sample obtained from a subject into the inlet of the Vortex HE microfluidic device and trapping CTCs within the plurality of expansion regions. The CTCs are then later released from the plurality of expansion regions by adjusting the flow rate of fluid pumped through the device (e.g., reducing the flow rate) and captured via the outlet of the microfluidic device.

In one particular embodiment, a microfluidic device for trapping cells includes at least one microfluidic channel that is formed in a substrate. The at least one microfluidic channel is coupled to an inlet and an outlet formed in the microfluidic device, the at least one microfluidic channel having a height of less than 50 μm and a width less than 30 μm (at locations other than the expansion regions). A plurality of expansion regions are disposed along a length of the at least one microfluidic channel, each of the plurality of expansion regions comprising an abrupt increase in the width of the at least one microfluidic channel, wherein the width of each expansion region is within the range of 526 μm to 626 μm and continues for a length within the range of 814 μm to 914 μm along a length of the expansion region, followed by an abrupt decrease in the width of the at least one microfluidic channel back to a width less than 30 μm.

In another particular embodiment, a microfluidic device for trapping cells includes at least one microfluidic channel that is formed in a substrate. The at least one microfluidic channel is coupled to an inlet and an outlet formed in the microfluidic device, the at least one microfluidic channel having a height of less than 50 μm and a width less than 30 μm (at locations other than the expansion regions). A plurality of expansion regions are disposed along a length of the at least one microfluidic channel, each of the plurality of expansion regions comprising an abrupt increase in the width of the at least one microfluidic channel, wherein the width of each expansion region is within the range of 650 μm to 750 μm and continues for a length within the range of 958 μm to 1058 μm along a length of the expansion region, followed by an abrupt decrease in the width of the at least one microfluidic channel back to a width less than 30 μm.

In another aspect of the invention, a method of capturing cells from a subject sample using any of the microfluidic devices described herein includes pumping a liquid biopsy sample from a subject into the inlet of the microfluidic device; trapping cells within the plurality of expansion regions; releasing cells from the plurality of expansion regions by adjusting the flow rate of fluid pumped through the microfluidic device; and capturing cells via the outlet of the microfluidic device.

### BRIEF DESCRIPTION OF THE DRAWINGS

FIG. 1A illustrates a schematic representation of a microfluidic device for trapping cells (e.g., the Vortex HE device) according to one particular embodiment. The device is illustrated in the 8×8 configuration with eight (8) parallel microfluidic channels with each channel with eight (8) expansion regions arranged in a serial manner along a single microfluidic channel. FIG. 1A further illustrates a highlighted region a. Region a is taken from a downstream expansion region. CTCs are trapped in the expansion region. White blood cells (WBCs) largely pass through the expansion region and continue down the device. The smaller red blood cells (RBCs) also enter the expansion region but are not stably trapped and continue down the device.

FIG. 1B illustrates the particular dimensions that were used in different variations or embodiments of the Vortex HE device. These included Vortex HE Device #2, Vortex HE Device #4 as well as two other variants Vortex HE Device #3, and Vortex HE Device #5.

FIG. 1C illustrates a microfluidic device in the form a microfluidic chip in which the inlet is connected to flexible tubing which connects to a pump.

FIG. 2 illustrates histogram data of the fraction of total particles that entered the expansion regions for devices with three different channel dimensions (Vortex HE Device #2, Vortex HE Device 4#, and microfluidic device #1 (representative of a prior art device)).

FIG. 3A illustrates traces of the trajectory of a bead in the presence of diluted whole blood.

FIG. 3B illustrates a histogram of the locations where particle trajectories intersect with the highlighted segment.

FIG. 3C illustrates changes in orbit variances extracted from FIG. 3B.

FIG. 4 illustrates a graph of capture efficiency of different devices (#1 (prior art), Vortex HE Devices #2-#5) to capture A549 cells spiked in phosphate buffered saline (PBS). Capture efficiency is defined as the number of captured cells or particles divided by the total number of cells or particles that are input through the device. Capture efficiency may also be expressed as the number of CTCs capture per volume of fluid input through the device.

FIG. 5 illustrates a graph of capture efficiency of different devices to capture A549 cells spiked in whole blood. Devices are labelled #1, #2, and #4 with device #1 being the prior art Vortex chip. Dilution factors are illustrated on the x-axis (10× or 20×). Purity is also illustrated in the second y-axis of FIG. 5. Purity is defined as the percentage of captured cancer cells divided by the total number of cells (e.g., cancer cells plus WBCs).

FIG. 6 illustrates the capture efficiency of cancer cells spiked in PBS for two devices (device #1 (prior art) and device #2 (Vortex HE)). Three different cell types were tested in the device (A549, VCaP, and MDA-MB-231).

FIG. 7 illustrates the concentration of CTCs captured per ml for device #1 (prior art) and device #4 for patient samples of lung cancer and prostate cancer. Also illustrated are purity results as represented by “x” data points and second y-axis.

FIG. 8 illustrates photographic images of viability tests performed on the captured cells from cells (A549) run through device #2 and device #4.

FIG. 9 illustrates a graph showing capture efficiency of different device geometries (microfluidic channel widths and expansion region dimensions tested at different Reynolds numbers. All units are in μm.)

FIG. 10 illustrates a graph of the capture efficiency of A549 cells in PBS in a device having a channel width of 18 μm and expansion region dimensions of 576 μm (width) and 864 μm (length) (i.e., Vortex HE2) and heights of 44 μm and 50 μm.

FIG. 11 illustrates a summary of capture efficiencies obtained in devices with different geometries.

FIG. 12 shows the different fraction of particles that were captured in Vortex devices having three different geometries: Vortex Gen 1 (prior art); Vortex HE1; Vortex HE2.

FIG. 13 illustrates the capture efficiency and purity of A549 cells spiked in diluted whole blood (10× and 20×) for different devices (Gen 1—prior art, Vortex HE1, and Vortex HE2).

FIG. 14 illustrates the improved performance of CTC capture efficiency for lung cancer, prostate cancer, and breast cancer using the improved Vortex HE1 device as compared to the Vortex Gen 1 (prior art) device. The y-axis shows the numbers of CTCs per volume (ml) (left axis) of whole blood and the number of WBCs/ml of whole blood (ml) (right axis).

### DETAILED DESCRIPTION OF THE ILLUSTRATED EMBODIMENTS

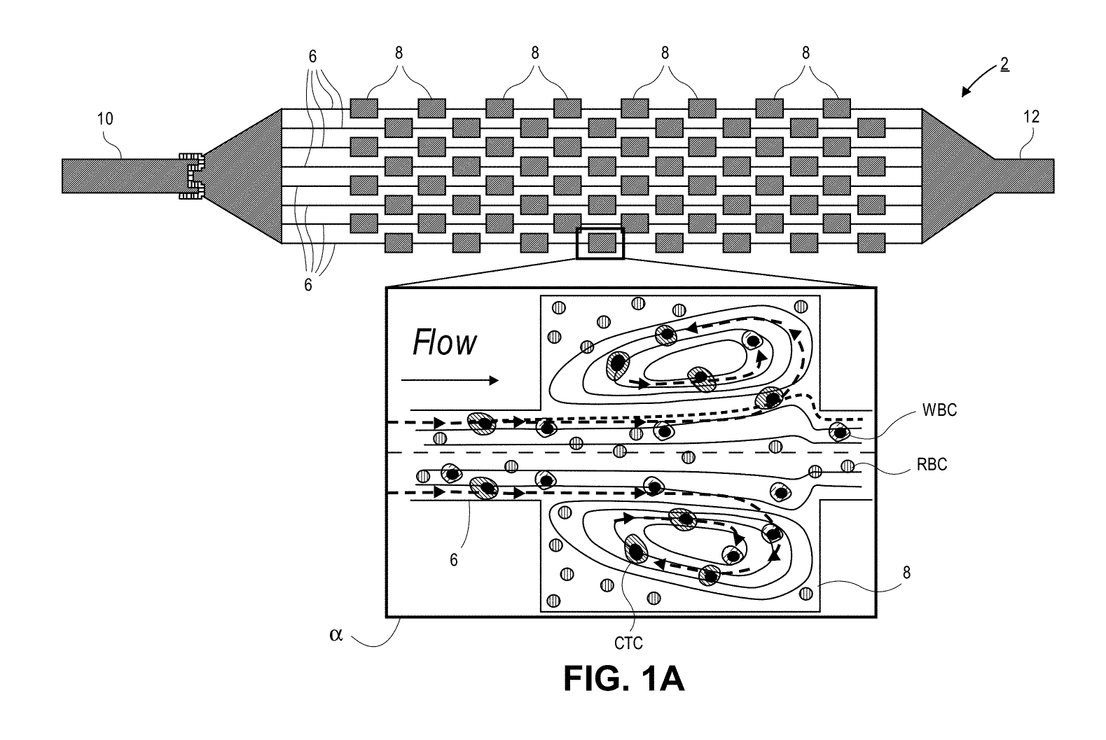

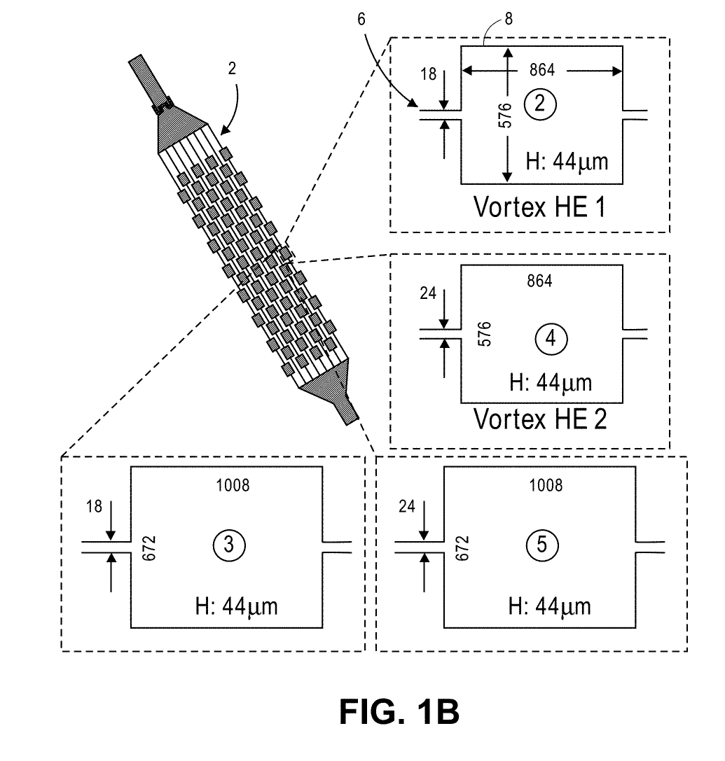

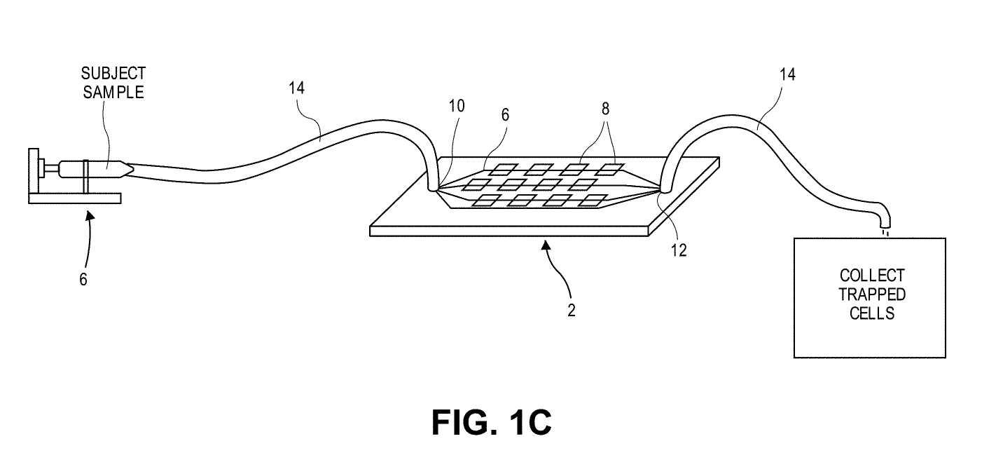

FIGS. 1A and 1B illustrate various embodiments of the microfluidic device 2 for trapping circulating tumor cells. As best seen in FIG. 1A, the microfluidic device 2 includes at least one microfluidic channel 6 that is formed in a substrate and coupled to an inlet 10 and an outlet 12. The device 2 is formed in a substrate that is typically made using standard photolithography or other techniques used in microfluidic devices. The device 2 may be made of any number of materials for the substrate such as, for example, silicon, glass, polymers or plastics (e.g., cyclic olefin polymer (COP), cyclic olefin copolymer (COC), polycarbonate (PC), poly(methyl methacrylate) (PMMA), polydimethylsiloxane (PDMS)). In the embodiments of FIGS. 1A and 1B, there are eight (8) separate channels 6 that are each coupled at a respective upstream ends to a common the inlet 10 although different numbers of channels 6 can be used as well. The inlet 10 may contain an optional filter 11 that is used to filter out larger particles and the like which would tend to clog the microfluidic device 2. The upstream region (upstream of the expansion regions 8) of the microfluidic channels 6 may act as a focusing microchannel 6. The length of the upstream region may vary but is generally around 500 μm in length.

Following the upstream focusing region of the channel 6, each separate channel 6 has, in this particular embodiment, eight (8) expansion regions 8 serially arranged along the length of the microfluidic channel 6 although different numbers of expansion regions 8 can also be employed. Each separate expansion region 8 may be separated by a similar distance such as around 500 μm. After the expansion regions 8, the microfluidic channels 6 communicate with a common outlet 12.

FIG. 1C illustrates microfluidic device 2 in the form a microfluidic chip in which the inlet 10 is connected to flexible tubing 14 which connects to a pump 16. The pump 16 may include a syringe pump although the invention is not limited to the type of pump 16 that is used. Any type of pump known to those skilled in the art that is used in microfluidic applications may be used. A liquid sample from a subject is pumped via the pump 16 into the microfluidic device 2. The liquid sample from the subject may include, by way of example, a liquid biopsy sample that is obtained from blood, cerebrospinal fluid, urine, pleural fluid, and the like. The obtained fluid may be diluted prior to being run through the device. For example, the obtained fluid may be diluted with PBS.

The flow rate at which the pump 16 operates may be controlled to adjust the flow rate through the microfluidic device 2. In one aspect, the flow rate is adjusted so that fluid flows through the microfluidic device 2 a Reynolds number within the range of 150-160. Flexible tubing 14 is also illustrated connected to the outlet 12. After passing through the microfluidic device 2 fluid and non-trapped cells exit via the outlet 12 and the flexible tubing 14. Trapped cells that are trapped in the expansion regions 8 can be released from the microfluidic device 2 whereupon they are collected after exiting the device via the outlet 12 and the flexible tubing 14. The cells may be collected in any number of known receptacles, containers, vials, or the like. Alternatively, the cells pay output to yet another microfluidic device (not shown) for further analysis (e.g., counting and imaging). The trapped cells may be released from the expansion regions 8 by adjusting the flow rate through the microfluidic device 2 such as by lowering the flow rate of sample or fluid through the device 2.

FIG. 1A illustrates how a liquid sample form a subject that contains CTCs, WBCs, and RBCs is run through the device. Region α illustrates a downstream expansion region. CTCs are trapped in the expansion region 8. WBCs largely pass the expansion region 8 or enter the expansion region 8 but are not stably trapped such they continue down the device (there may be a few WBCs that are stably trapped in the vortices created in the expansion regions 8). The smaller RBCs enter the expansion region but are not stably trapped and continue down the device.

Preferably, the at least one microfluidic channel 6 has a height of less than 50 μm and a width less than 30 μm (excluding the widths within the expansion regions 8). In one embodiment of the invention, the height is about 44 μm and the width is about 24 μm. In another embodiment, the height is about 44 μm and the width is about 18 μm. The height of the at least one microfluidic channel 6 is the same throughout the entire length of the microfluidic channel 6, including the through the expansion regions 8. In one embodiment, a plurality of expansion regions 8 are disposed along the length of each microfluidic channel 6, wherein each of the plurality of expansion regions 8 is an abrupt increase in the width of the at least one microfluidic channel 6 which lasts for a length followed by an abrupt decrease in the width of the at least one microfluidic channel 6. In one embodiment, the width of the expansion regions 8 falls within the range of range of 526 μm to 626 μm. The expansion regions 8 continue for a length at this expanded width before returning to the reduced width of the microfluidic channel 6 (e.g., less than 30 μm) in an abrupt decrease. In one embodiment, each expansion region 8 continues for a length within the range of 814 μm to 914 μm, followed by an abrupt decrease in width back to a width less than 30 μm. As one particular example that falls within this range, the width of each expansion region 8 is at least 570 μm and lasts for at least 850 μm along a length of the expansion region 8, followed by an abrupt decrease in the width of the expansion region 8 back to a width less than 30 μm. The height of the expansion region 8 and the height of the microfluidic channel are less than 50 μm. In one aspect, the microfluidic channel 6 (excluding those portions where the expansion regions 8 are located) has an aspect ratio (height: width) within the range of about 1.5 to about 2.5.

In another embodiment, the width of the expansion regions 8 falls within the range of 650 μm to 750 μm. The expansion regions 8 continue for a length at this expanded width before returning to the reduced width of the microfluidic channel 6 (e.g., less than 30 μm) in an abrupt decrease. In one embodiment, each expansion region 8 continues for a length within the range of 958 μm to 1058 μm, followed by an abrupt decrease in width back to a width less than 30 μm. As one particular example that falls within this range, the width of each expansion region 8 is at least 700 μm and lasts for at least 1008 μm along a length of the expansion region 8, followed by an abrupt decrease in the width of the expansion region 8 back to a width less than 30 μm. The height of the expansion region 8 and the height of the microfluidic channel are less than 50 μm. In one aspect, the microfluidic channel 6 (excluding those portions where the expansion regions 8 are located) has an aspect ratio (height: width) within the range of about 1.5 to about 2.5.

As seen in FIG. 1B, device #2 includes a microfluidic channel 6 having a height of 44 μm and a width of 18 μm that enters an expansion region 8 that has a width of 576 μm that continues for 864 μm in length until the width abruptly decreases back to the original width of 18 μm. Device #3 includes a microfluidic channel 6 having a height of 44 μm and a width of 18 μm that enters an expansion region 8 that has a width of 672 μm that continues for 1008 μm in length until the width abruptly decreases back to the original width of 18 μm. Device #4 includes a microfluidic channel 6 having a height of 44 μm and a width of 24 μm that enters an expansion region 8 that has a width of 576 μm that continues for 864 μm in length until the width abruptly decreases back to the original width of 24 μm. Device #5 includes a microfluidic channel 6 having a height of 44 μm and a width of 24 μm that enters an expansion region 8 that has a width of 672 μm that continues for a length of 1008 μm until the width abruptly decreases back to the original width of 24 μm.

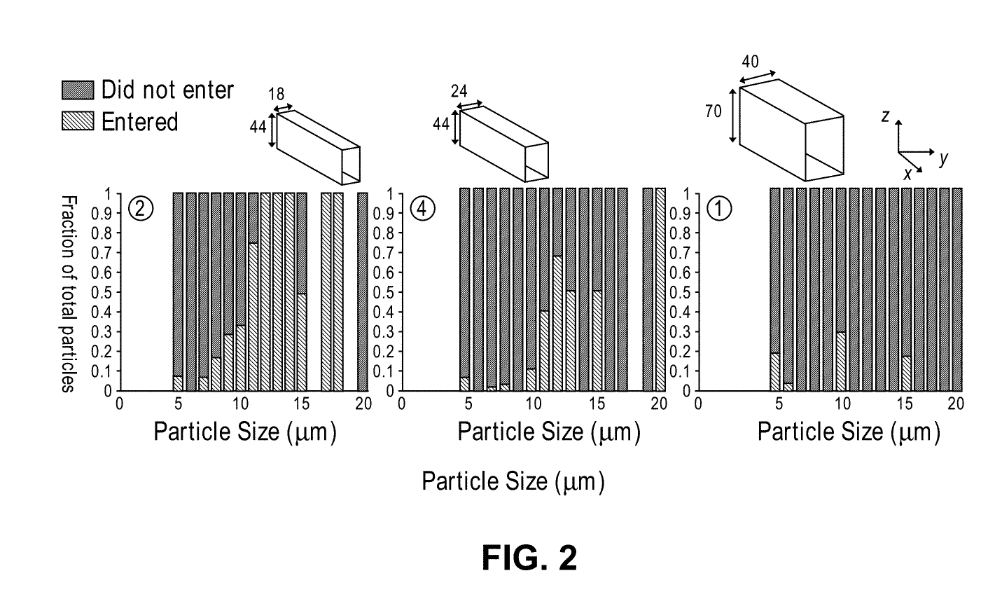

It has been found, quite unexpectedly, that by scaling down the width and height of the microfluidic channels 6 prior to entering the expansion regions 8, particle entry rate into the expansion regions 8 (for smaller particles) is significantly enhanced. For all studies described herein the Reynolds number (Re) was maintained between about 150 and about 160 (with 160 being preferred). Microfluidic trapping devices having channel widths (18 μm and 24 μm) and height (44 μm) capture a larger fraction of particles in the size range 12-18 μm than the prior version of the Vortex device. This is seen in the data in FIG. 2 where PDMS beads of size range between 5-20 μm were inserted into three different microfluidic devices (device #2, device #4, device #1—prior art) and with three different channel dimensions. While a larger fraction of particles in the size range of 12-18 μm is seen, improved results are seen for particles outside this range, namely particles having sizes greater than or equal to 12 μm. For a constant Re, as the microfluidic channel dimensions decrease, the velocity increases, leading to a larger shear-gradient lift, which allows a larger fraction of smaller particles to migrate into the expansion region 8 which is seen in device #2 and device #4.

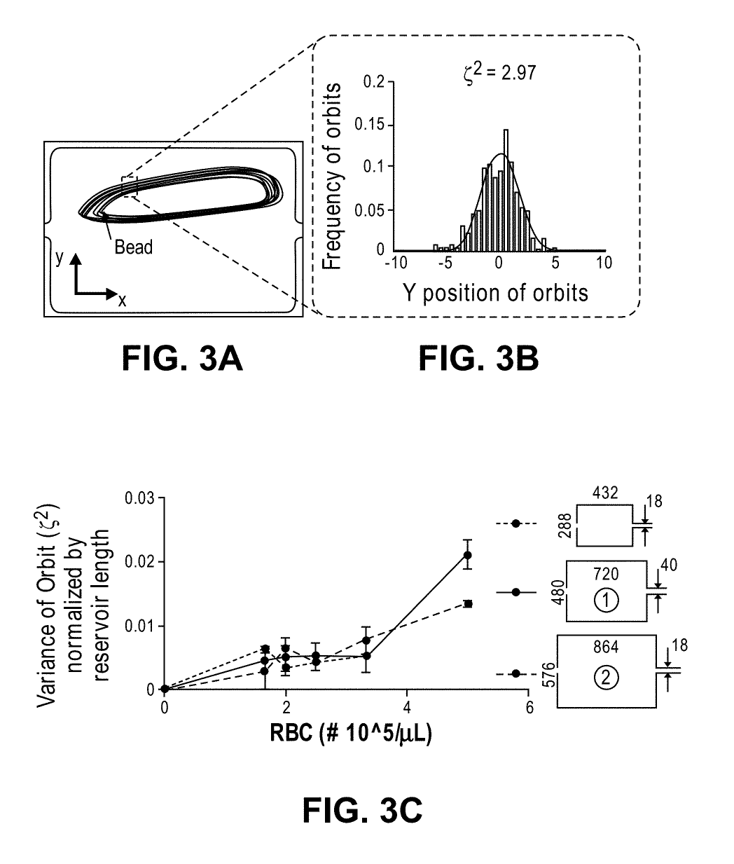

The size of the expansion region 8 influences the maintenance of particles following trapping and contributes to the capture efficiency. In diluted blood solutions, the large amount of remaining red blood cells (RBCs) can perturb trapped particles from stable orbits due to hydrodynamic interactions. Using a particle tracking algorithm, the motion of 20 μm polystyrene beads in the presence of RBCs trapped in an expansion region was studied. FIG. 3A illustrates the traces of a bead trajectory in the presence of diluted whole blood. FIG. 3B shows the distribution of particle trajectories fit a Gaussian curve. The variance of the fit corresponds to the variance of the trajectory. Increase in the number of RBCs in the expansion region 8 increases the trajectory variance (FIG. 3C). This occurs due to changes in particle stability (i.e., a higher variance indicates a lower stability of the trajectory and higher likelihood of a cell being ejected from the vortex).

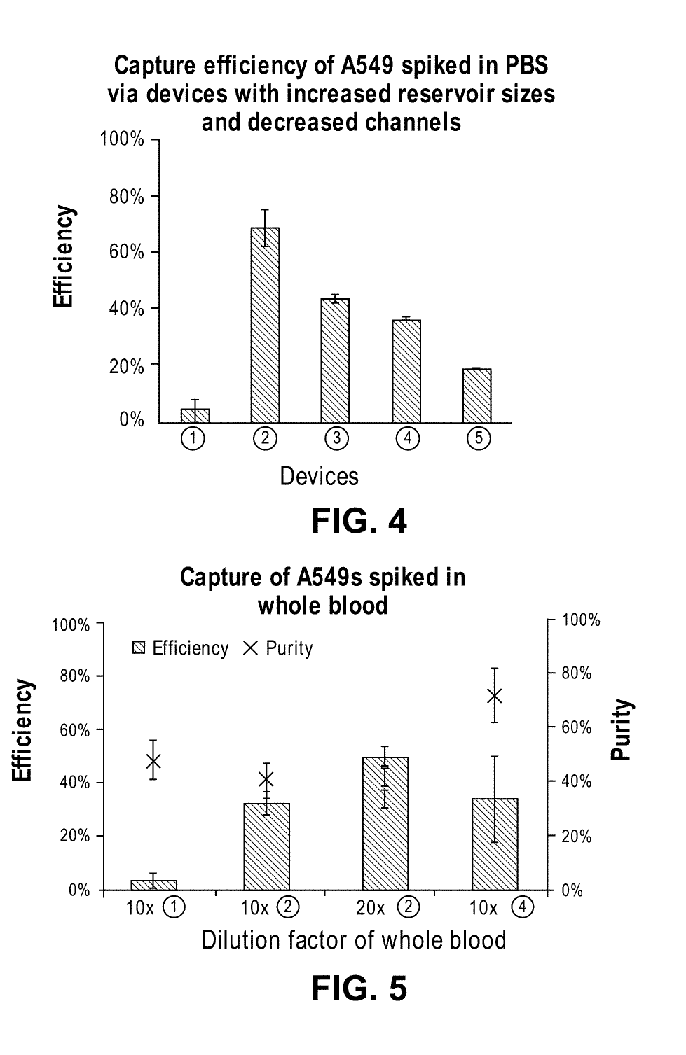

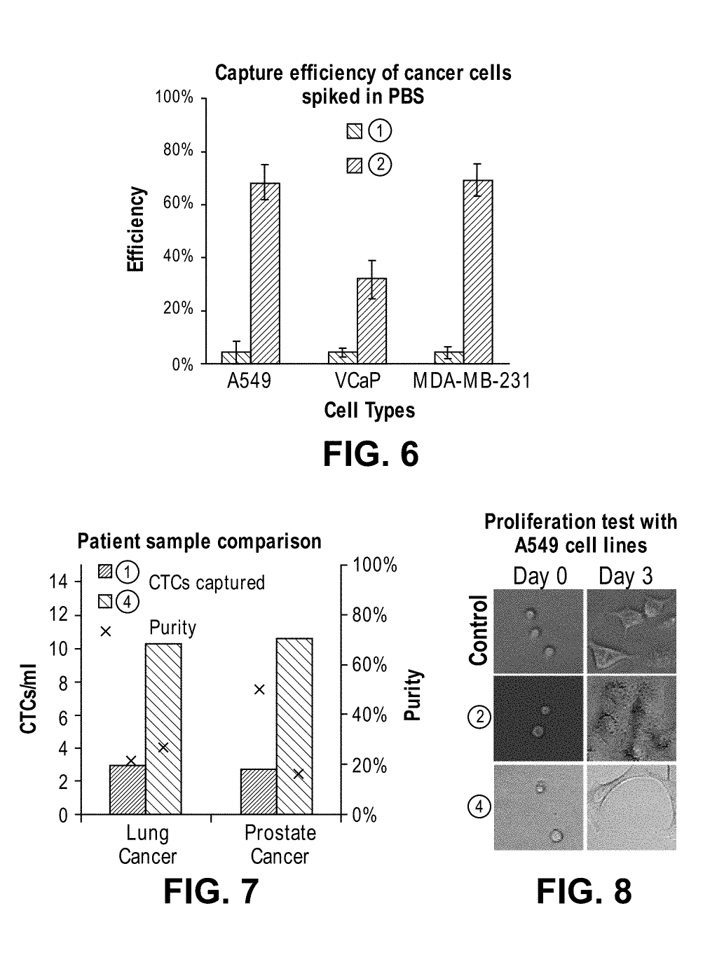

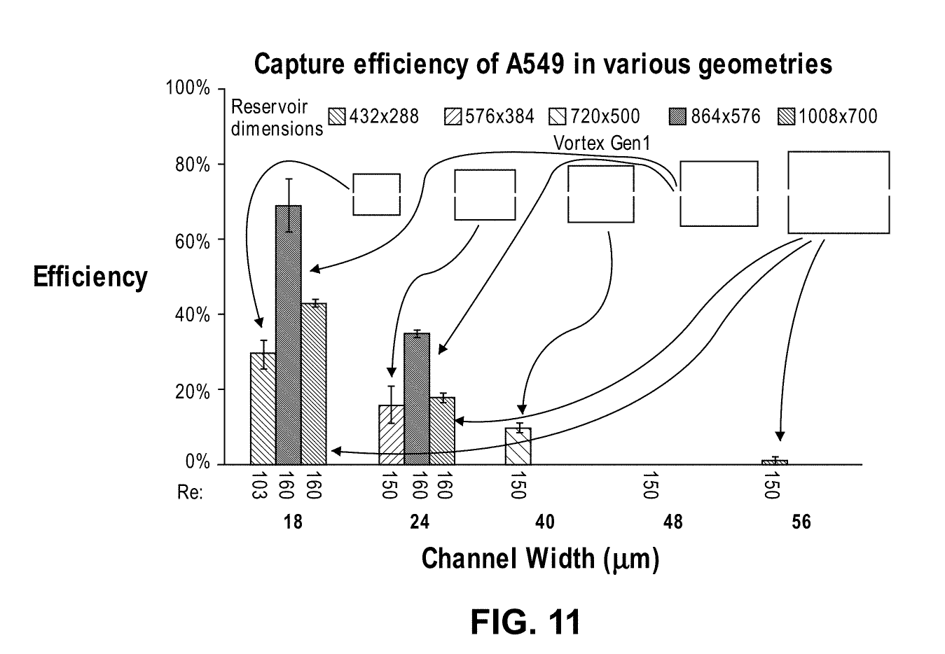

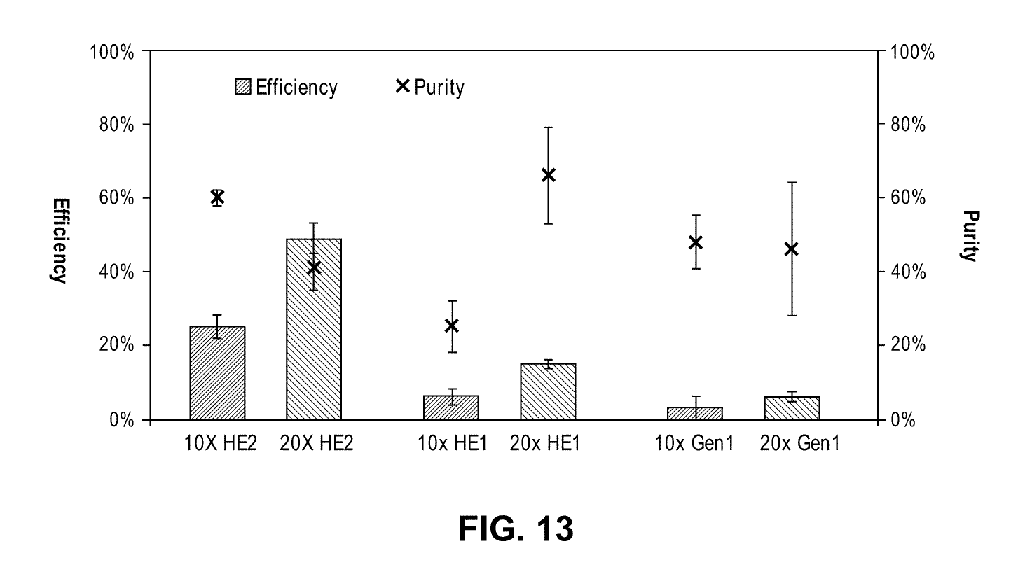

While multiple different embodiments were tried, there were two final device designs: Vortex HE1—Device #2; and Vortex HE2—Device #4 that showed the largest improvements in performance. Device #4 has the highest capture efficiency in dilute solutions (69%) (as seen in FIG. 11) while device #2 has a capture efficiency of 15% and retains high purity of 72% of A549 cells in blood (FIG. 13). Device #2 exhibits the largest increase in capture efficiency for cell lines in PBS (FIG. 4), and may be optimal for isolating rare cells in dilute solutions like urine. Device #2 was able to increase capture efficiency across different cell types as seen by FIG. 6 as compared to the prior version of the Vortex device.

As seen in FIG. 6, the high capture efficiency is valid for three different cell lines: A549, MDA-MB-231, and VCaPs. This experiment was also performed with the original (prior art) Vortex device labeled as Device #1 or Gen1. The new design of device #2 had channel width 18 μm, expansion region dimension 864 μm length, 576 μm width, and height 44 μm. The Gen1 or Device #1 was operated at 4 ml/min (Re=150), while device #2 was operated at 2.4 ml/min (Re=160).

Given these results, one now has tunable control over the types of cells one can isolate from a biological sample such as blood. The improved microfluidic device 2 is able to isolate CTCs from lung cancer patients who are treated with anti-PD-1 immunotherapy drug (FIG. 7). It was found that the CTCs of these patients express PD-L1, a receptor associated with response to immunotherapy. These results indicate that CTCs from a non-invasive liquid biopsy can be collected and stained for predictors of immunotherapy efficacy towards an improved biopsy-free companion diagnostic. FIG. 7 also illustrates enhanced isolation of CTCs from prostate cancer.

The improved microfluidic device 2 also shows good results for cell viability. FIG. 8 illustrates that A549 cells that are run through the improved microfluidic device 2 are viable after being run through and trapped. FIG. 8 compares the control test with A549 cells run through the device #2 and device #4 as described herein. The A549 cells were viable after three days.

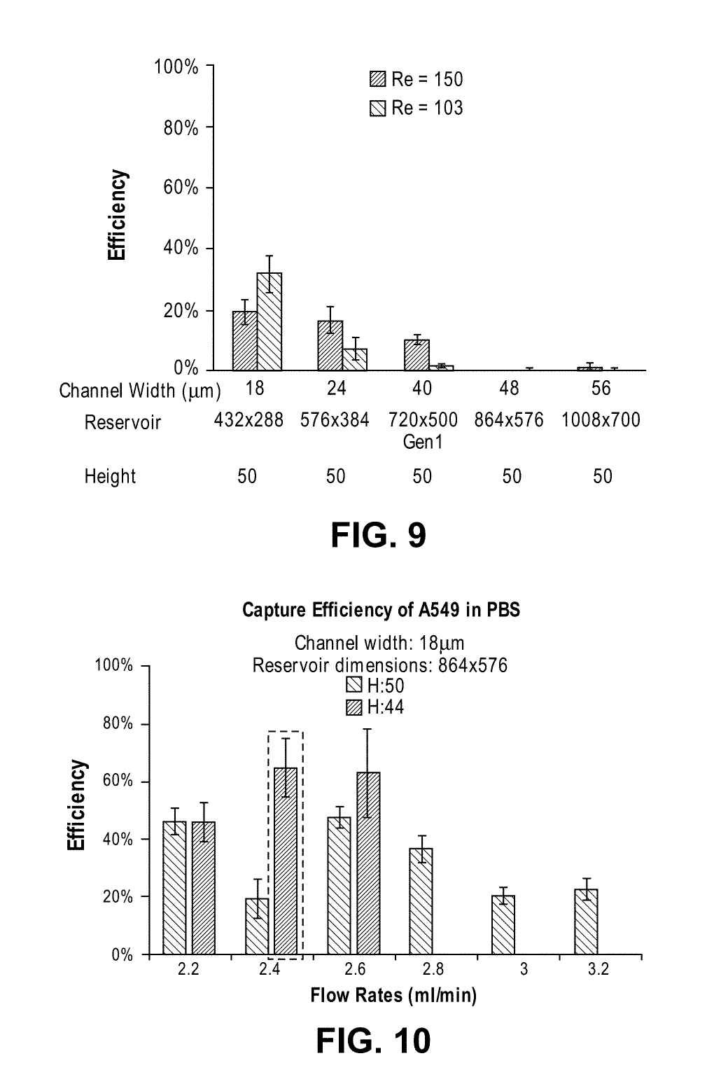

FIG. 9 illustrates a graph showing capture efficiency of cells in devices having different device geometries. Various microfluidic channel widths were tested (18 μm, 24 μm, 40 μm, 48 μm, and 56 μm) along with different expansion region 8 dimensions. Tested dimensions for the expansion region 8 included: 432 μm (length)×288 μm (width); 576 μm (length)×384 μm (width); 720 μm (length)×500 μm (width) (prior art); 864 μm (length)×576 μm (width); 1008 μm (length)×700 μm (width). For all experiments the height of the microfluidic channel was 50 μm). Two different Reynolds numbers were tested with uniformed scaled devices. These devices had either scaled down expansion region and scaled down microfluidic channel, or scaled up expansion region and scaled up microfluidic channel compared to prior version of the Vortex device. The higher Reynolds number works better for all the devices except for the device with the microfluidic channel 6 having a width of 18 μm. While the results illustrated in FIG. 9 illustrate improved results as compared to the prior art Gen1 device, it was found that much better results could be achieved by scaling down the dimension of the microfluidic channel 6 while scaling up the dimensions of the expansion region 8. This unexpectedly produced significantly better capture efficiency results.

FIG. 10 illustrates a graph of the capture efficiency of A549 cells in PBS in a microfluidic device having a channel width of 18 μm and expansion region dimensions of 576 μm (width) and 864 μm (length) (i.e., Vortex HE2). The scaled down dimension of the entry channel (18 μm) is coupled with a larger expansion region size to improve capture efficiency. The height of the device is very sensitive. It was found that the height of 44 μm performs better than the 50 μm height. Various flow rates were also tested as seen from the data in FIG. 10. The optimal flow rate is 2.4 ml/min (seen by dashed line in FIG. 10). This flow rate corresponds to a Reynolds number of 160 for the 44 μm height device.

FIG. 11 illustrates a summary of measured capture efficiencies obtained in microfluidic devices with different geometries used for the expansion region 8 and the dimension of the incoming microfluidic channel 6. The flow rates that achieved the maximum capture for each device was used. Capture efficiency of the small A549 cells increases with decreasing focusing channel dimensions (i.e., the width of the microfluidic channel 6 leading to the region containing the expansion regions 8). Uniformly scaling down both the microfluidic channel 6 and the dimensions of the expansion region 8 improves capture of the A549s compared to the Vortex Gent (prior art) device a maximum of 1.5 times (indicated by 432 μm (length)×288 μm (width) data). Interestingly, coupling the narrow entry microfluidic channel 6 with larger-sized expansion regions 8 achieved much better capture that is 7 times better than Vortex Gent (prior art). The optimal size of the expansion region 8 that reaches this capture efficiency is 120% larger than the Vortex Gent device (864 μm (length)×576 μm (width) data). Further increasing the size of the expansion region 8, however, lowers the capture efficiency as seen in the 1008 μm (length)×700 μm (width) data. For the larger incoming microfluidic channel 6 widths, increasing the Reynolds number beyond 150 did not help more particles enter. In addition, the filter regions upstream in the microfluidic device 2 started delaminating at higher Reynolds number.

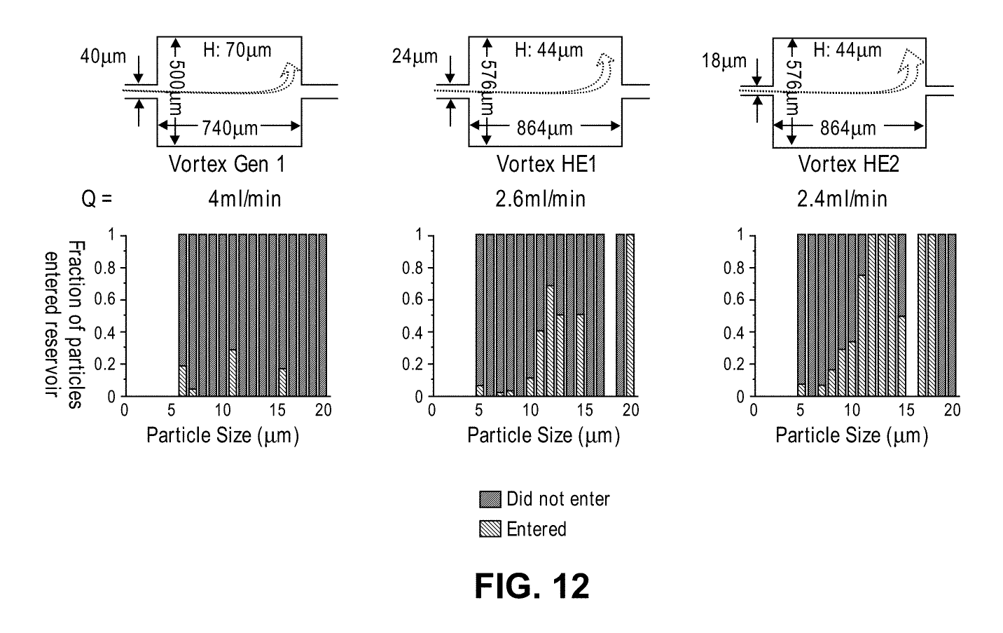

With reference to FIG. 12, the high capture phenomena discovered in the new microfluidic device 2 geometries may be explained by the entry mechanism of the particles (PDMS beads). The data shown in bars labeled as “Entered” is the fraction of particles that entered the expansion regions 8. The bars labeled as “Did not enter” are the fraction of particles that did not enter the expansion regions 8. The blank spaces indicate no particles of that size were present in the solution. From the particle entry analysis one finds that reducing the width of the entry microfluidic channel 6 and height improves particle migration into the trapping expansion regions 8 as shown. A larger fraction of PDMS particles in the size range 10-18 μm enter the expansion regions 8 when the microfluidic channel 6 width is decreased to 18 μm or 24 μm from the original 40 μm and the height is reduced to 44 μm from the original 70 μm. The microfluidic channels 6 still maintain their high aspect ratios in order to focus particles towards the sidewalls. In these experiments the flow rates used correspond to that which yields the highest capture efficiency for each device.

For the experiments illustrated in FIG. 12, dilute PDMS particles (<20 um diameter) with a concentration of 1,000 particles per ml was infused into each microfluidic device. The volume of fluid analyzed was also kept constant such that the same concentrations of particles would be infused in each experiment. Particle entry into expansion regions was quantified by analyzing high speed video taken of the particles as they entered or passed the expansion regions. A Phantom v2010 high speed camera was used at a frame rate of 9,000 frames per second to capture images. Video from six expansion regions were combined to generate this data. A semi-automated image processing algorithm developed in MATLAB was used to find the number and size of particles that either enter or pass by the expansion regions. The flow rate operating parameters for each microfluidic device is seen in FIG. 12.

With reference to FIG. 13, A549 cells were spiked into 10× and 20× diluted healthy whole blood (diluted with PBS) and were run through the HE1 (microchannel width of 24 μm, expansion region dimension of 864 μm (length)×576 μm (width) and height 44 μm)), HE2 (microchannel width of 18 μm, expansion region dimensions of 576 μm (width) and 864 μm (length)), and Gen1 (prior art) (microchannel width of 40 μm, expansion region dimensions of 500 μm (width) and 740 μm (length)) microfluidic devices. The capture efficiency of A549 cells spiked in diluted blood is much higher in the HE2 and HE1 microfluidic devices as compared to the Gen1 microfluidic device. However, the purity decreases because a larger fraction of 12-15 micrometer diameter white blood cells are trapped as well in the new devices. A balance between high capture of cancer cells and high purity can be achieved with the microfluidic devices with the HE1 configuration. Furthermore, working with 20× dilution of whole blood with the HE1 devices yields 2.5× higher capture of cancer cells and similar numbers of white blood cells compared to Gen1. The HE1 microfluidic device also clogs less than HE2 microfluidic device because of slightly larger filter designs. These devices can be used to capture CTCs from patient samples.

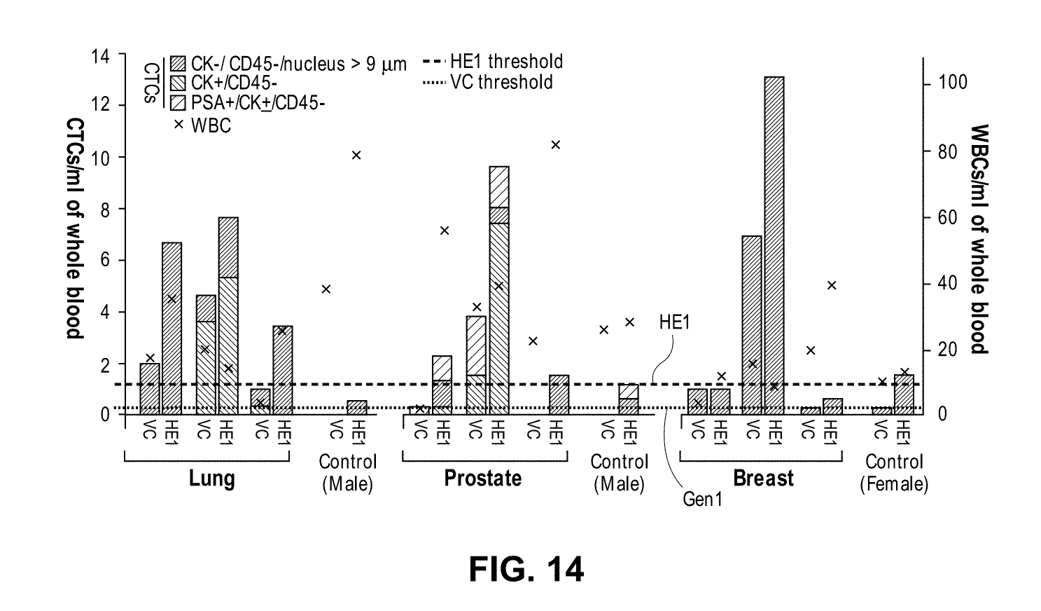

FIG. 14 illustrates the results of processing blood samples from three different types of cancer patients with a microfluidic device with the HE1 geometry. Three ml of blood from three (3) non-small cell lung cancer (NSCLC) patients, three (3) prostate cancer patients, and three (3) breast cancer patients were processed. NSCLC CTCs were classified by DAPF/CK+/CD45− or DAPI+/CK−/CD45− nucleus larger than 9 μm and high nuclear to cytoplasm ratio. CK+/CD45− is a common classification for cancer cells. CK−/CD45− and nucleus larger than 9 μm is a common classification for non-epithelial cells CTCs. All three lung cancer samples had higher CTCs counts from the microfluidic device with the HE1 geometry as compared to the Gen1 microfluidic device. A total of 20, 23 and 13 CTCs were collected through the HE1 microfluidic devices, while a total of 8, 16, and 3 CTCs were collected with the Gen1 Vortex devices. The prostate CTCs were classified using the DAPF/CK+,−/PSA+/CD45−, DAPF/CK+/PSA−/CD45−, DAPI+/CK−/PSA−, CD45− nucleus larger than 9 μm and high nuclear to cytoplasm ratio. The total prostate CTCs collected from 3 ml of blood was 32, 7, 6 using the HE1 microfluidic device, whereas it was 12, 1, 0 using the Gen' microfluidic device. Breast cancer CTCs were classified by DAPI+/CK+/CD45− or DAPI+/CK−/CD45− nucleus larger than 9 μm and high nuclear to cytoplasm ratio. The total breast cancer CTCs collected from 3 ml of blood was 3, 39, 2 using the HE1 device, whereas it was 3, 21, 1 using the Gen1 device.

FIG. 14 shows the ability to isolate different types of CTCs with the microfluidic device that have both epithelial or non-epithelial nature. FIG. 14 further illustrates (in dashed lines) the respective diagnosis thresholds for both the HE1 microfluidic device and the Gen1 microfluidic device. If the number of CTC-like cells (defined used classification scheme noted above) falls above this threshold, the sample that is run through the microfluidic is deemed positive. Conversely, of the number of CTC-like cells falls below this threshold, the sample is deemed negative. As seen in FIG. 14, the HE1 microfluidic device has a higher threshold than the threshold of the Gen1 microfluidic device.

While embodiments of the present invention have been shown and described, various modifications may be made without departing from the scope of the present invention. The invention, therefore, should not be limited, except to the following claims, and their equivalents.

1. A microfluidic device for trapping cells comprising:
at least one microfluidic channel coupled to an inlet and an outlet, the at least one microfluidic channel having a height of less than 50 μm and a width less than 30 μm; and
a plurality of expansion regions disposed along a length of the at least one microfluidic channel, each of the plurality of expansion regions comprising an abrupt increase in the width of the at least one microfluidic channel, wherein the width of each expansion region is within the range of 526 μm to 626 μm and continues for a length within the range of 814 μm to 914 μm along a length of the expansion region, followed by an abrupt decrease in the width of the at least one microfluidic channel back to a width less than 30 μm.

2. The microfluidic device of claim 1, further comprising a pump connected to the inlet.

3. The microfluidic device of claim 1, wherein the at least one microfluidic channel comprises a plurality of microfluidic channels coupled to the inlet and the outlet.

4. The microfluidic device of claim 1, wherein the height of the at least one microfluidic channel is about 44 μm.

5. The microfluidic device of claim 1, wherein the width of the at least one microfluidic channel is between about 18 μm and about 24 μm.

6. The microfluidic device of claim 1, wherein the height of the at least one microfluidic channel and the height of the plurality of expansion regions are the same.

7. The microfluidic device of claim 1, wherein the width of the each expansion region is about 576 μm and lasts for about 864 μm along a length of the expansion region.

8. The microfluidic device of claim 2, wherein the pump pumps fluid containing cells through the at least one microfluidic channel at a Reynolds number within the range of about 150 to about 160.

9. The microfluidic device of claim 1, wherein the microfluidic channel has an aspect ratio (height: width) within the range of about 1.5 to about 2.5.

10. The microfluidic device of claim 2, wherein the pump is coupled to a fluid source containing a biological sample into the inlet of the microfluidic device.

11. A method of capturing cells from a subject sample using the microfluidic device of claim 1 comprising:
pumping a liquid biopsy sample from a subject into the inlet of the microfluidic device;
trapping cells within the plurality of expansion regions;
releasing cells from the plurality of expansion regions by adjusting the flow rate of fluid pumped through the microfluidic device; and
capturing cells via the outlet of the microfluidic device.

12. The method of claim 11, wherein the cells comprise CTCs.

13. The method of claim 11, wherein the liquid biopsy sample comprises one of blood, urine, or cerebrospinal fluid.

14. The method of claim 11, wherein the trapped cells have a size of at least 12 μm.

15. A microfluidic device for trapping cells comprising:
at least one microfluidic channel coupled to an inlet and an outlet, the at least one microfluidic channel having a height of less than 50 μm and a width less than 30 μm; and
a plurality of expansion regions disposed along a length of the at least one microfluidic channel, each of the plurality of expansion regions comprising an abrupt increase in the width of the at least one microfluidic channel, wherein the width of each expansion region is within the range of 650 μm to 750 μm and continues for a length within the range of 958 μm to 1058 μm along a length of the expansion region, followed by an abrupt decrease in the width of the at least one microfluidic channel back to a width less than 30 μm.

16. The microfluidic device of claim 15, further comprising a pump connected to the inlet.

17. The microfluidic device of claim 15, wherein the at least one microfluidic channel comprises a plurality of microfluidic channels coupled to the inlet and the outlet.

18. The microfluidic device of claim 15, wherein the height of the at least one microfluidic channel is about 44 μm.

19. The microfluidic device of claim 15, wherein the width of the at least one microfluidic channel is about 24 μm.

20. The microfluidic device of claim 15, wherein the width of the at least one microfluidic channel is about 18 μm.
